(19) United States
(12) Patent Application Publication
(10) Pub. No.: US 2013/0300668 A1
(43) Pub. Date: Nov. 14, 2013

(54) Grip-Based Device Adaptations

(71) Applicant: Microsoft Corporation, Redmond, WA (US)

(72) Inventors: Anatoly Churikov, Kaliningrad (RU); Catherine N. Boulanger, Redmond, WA (US); Hrvoje Benko, Seattle, WA (US); Luis E. Cabrera-Cordon, Bothell, WA (US); Paul Henry Dietz, Redmond, WA (US); Steven Nabil Bathiche, Kirkland, WA (US); Kenneth P. Hinckley, Redmond, WA (US)

(21) Appl. No.: 13/898,452

(22) Filed: May 20, 2013

Related U.S. Application Data
(63) Continuation-in-part of application No. 13/352,193, filed on Jan. 17, 2012.

(51) Int. Cl. G06F 3/041

(52) U.S. Cl. CPC G06F 3/041
USPC 345/168; 345/173

(57) ABSTRACT

Grip-based device adaptations are described in which a touch-aware skin of a device is employed to adapt device behavior in various ways. The touch-aware skin may include a plurality of sensors from which a device may obtain input and decode the input to determine grip characteristics indicative of a user's grip. On-screen keyboards and other input elements may then be configured and located in a user interface according to a determined grip. In at least some embodiments, a gesture defined to facilitate selective launch of on-screen input element may be recognized and used in conjunction with grip characteristics to launch the on-screen input element in dependence upon grip. Additionally, touch and gesture recognition parameters may be adjusted according to a determined grip to reduce misrecognition.

### PRIORITY

This application is a continuation-in-part of and claims priority under 35 U.S.C. §120 to U.S. patent application Ser. No. 13/352,193, filed on Jan. 17, 2012 and titled “Skinnable Touch Device Grip Patterns,” the disclosure of which is incorporated by reference in its entirety herein.

### BACKGROUND

One challenge that faces designers of devices having user-engageable displays, such as touchscreen displays, is recognition of user input and distinguishing intended user action from inadvertent contact with a device. For example, contact with a touchscreen due to the way a user is holding a device may be misinterpreted as an intended touches or gestures. Further, input elements of a user interface such as on-screen keyboards, dialogs, buttons, and selection boxes are traditionally exposed at preset and/or fixed locations within the user interface. In at least some scenarios, the manner in which a user holds a device may make it difficult to interact with these preset and/or fixed input elements. For instance, the user may have to readjust their grip on the device to reach and interact with some elements, which slows down the interaction and may also lead to movement and unintentional contacts with the device that could be misinterpreted as gestures. If input is consistently misrecognized, user confidence in the device may be eroded. Accordingly, traditional techniques employed for on-screen input elements and touch recognition may frustrate users and/or may be insufficient in some scenarios, use cases, or specific contexts of use.

### SUMMARY

Grip-based device adaptations are described. In one or more embodiments, a computing device is configured to include a touch-aware skin. The touch-aware skin may cover substantially the outer surfaces of the computing device that are not occupied by other components. The touch-aware skin may include a plurality of sensors capable of detecting interaction at defined locations. The computing device may be operable to obtain input from the plurality of skin sensors and decode the input to determine grip characteristics that indicate how the computing device is being held by a user. On-screen keyboards and other input elements may then be configured and located in a user interface according to a determined grip. In at least some embodiments, a gesture defined to facilitate selective launch of an on-screen input element may be recognized and used in conjunction with grip characteristics to launch the on-screen element in dependence upon grip. Additionally, touch and gesture recognition parameters may be adjusted according to a determined grip to reduce misrecognition.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an example implementation of an environment that is operable to employ grip-based device adaptation techniques described herein.

FIG. 2 depicts details of an example computing device that includes a touch-aware skin.

FIG. 3 depicts an example implementation of a touch-aware skin for a computing device.

FIG. 4 is a flow diagram depicting an example procedure to customize on-screen input elements in accordance with one or more embodiments.

FIGS. 5a, 5b, and 5c depict examples of customized on-screen input elements in accordance with one or more implementations.

FIGS. 6a, 6b, and 6c depict examples of customized on-screen keyboards in accordance with one or more implementations.

FIG. 7 depicts another example of a customized on-screen keyboard in accordance with one or more implementations.

FIG. 8 is a flow diagram depicting an example procedure to implement a launch gesture for an on-screen keyboard.

FIG. 9 depicts an example launch gesture in accordance with one or more implementations.

FIG. 10 depicts another example launch gesture in accordance with one or more implementations.

FIG. 11 is a flow diagram depicting an example procedure to adjust recognition parameters in accordance with an interaction context.

FIG. 12 illustrates various components of an example system that can be employed in one or more embodiments to implement aspects of grip-based device adaptation techniques described herein.

### DETAILED DESCRIPTION

Overview

Distinguishing intended user action from inadvertent contact with a device is one challenge that faces designers of devices having user-engageable displays. In addition, designers of devices are continually looking to improve the accuracy and efficiency of touch and gestural input supported by devices to make it easier for users to interact with device, and thereby increase the popularity of the devices.

Grip-based device adaptations are described. In one or more embodiments, a computing device is configured to include a touch-aware skin. The touch-aware skin may cover substantially the outer surfaces of the computing device that are not occupied by other components. The touch-aware skin may include a plurality of sensors capable of detecting interaction at defined locations. The computing device may be operable to obtain input from the plurality of skin sensors and decode the input to determine grip characteristics that indicate how the computing device is being held by a user. On-screen keyboards and other input elements may then be configured and located in a user interface according to a determined grip. In at least some embodiments, a gesture defined to facilitate selective launch of an on-screen input element may be recognized and used in conjunction with grip characteristics to launch the on-screen element in dependence upon grip. Additionally, touch and gesture recognition parameters may be adjusted according to a determined grip to reduce misrecognition.

In the following discussion, an example operating environment is first described that is operable to employ the grip-based device adaptation techniques described herein. Example details of techniques for grip-based device adaptation are then described, which may be implemented in the example environment, as well as in other environments. Accordingly, the example devices, procedures, user interfaces, interactions scenarios, and other aspects described herein are not limited to the example environment and the example environment is not limited to implementing the example aspects that are described herein. Lastly, an example computing system is described that can be employed to implement grip-based device adaptation techniques in one or more embodiments.

Operating Environment

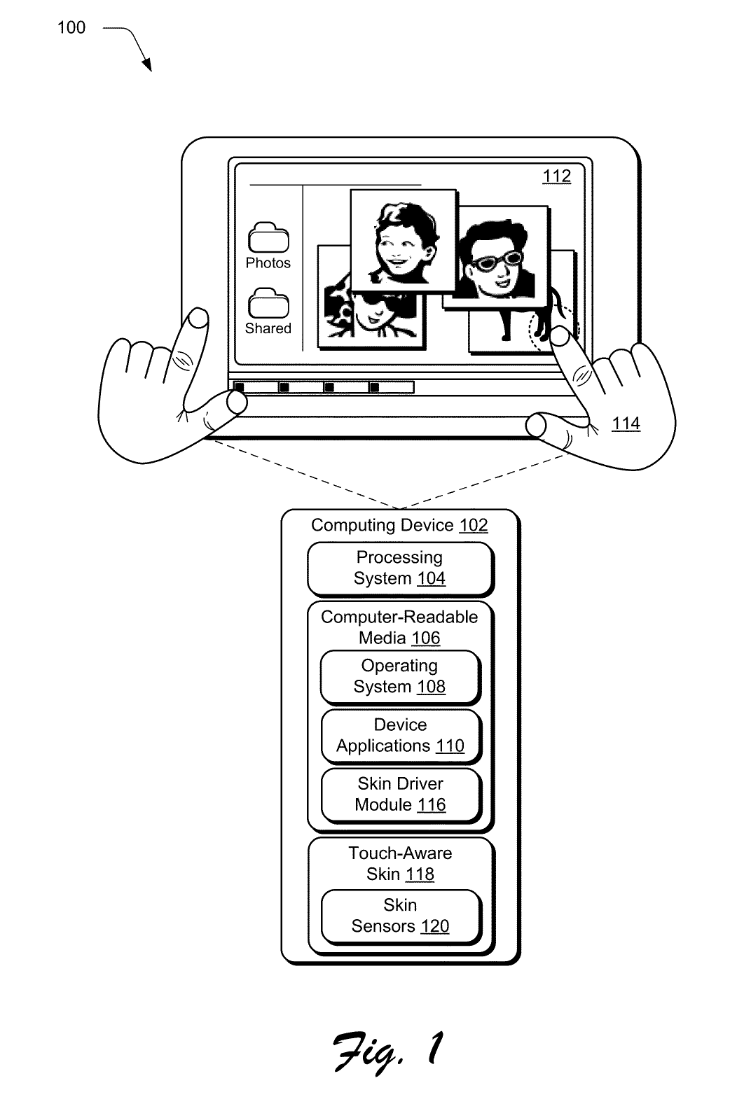

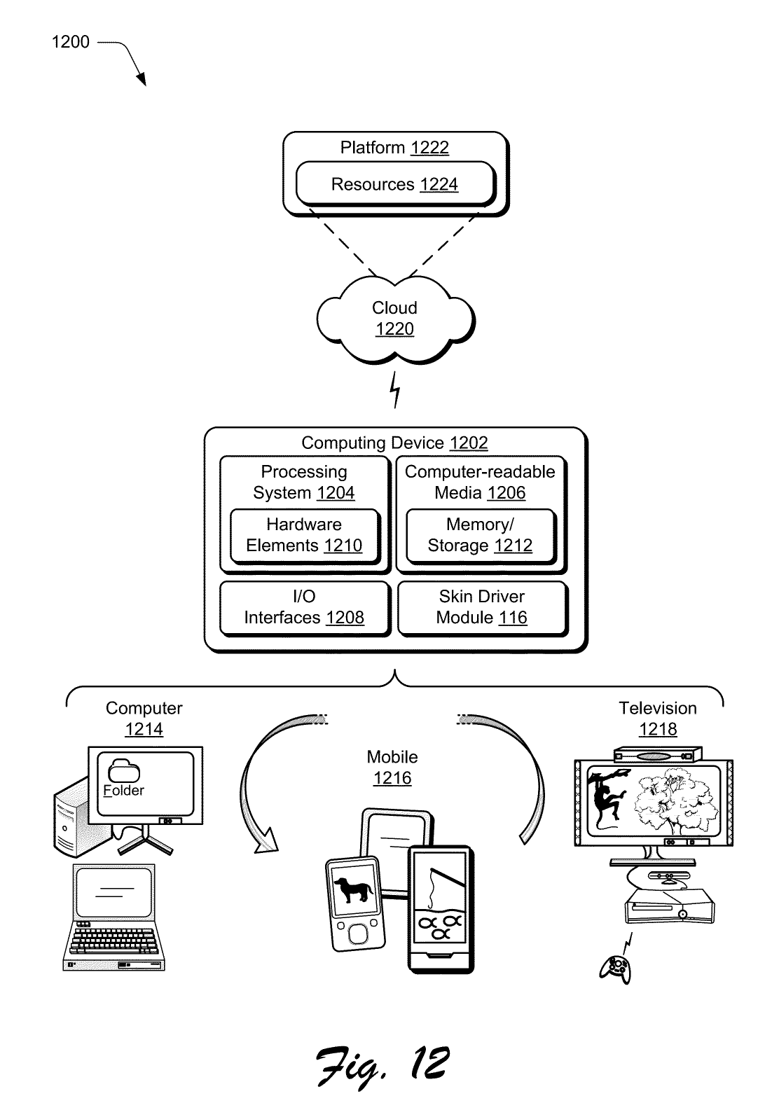

FIG. 1 is an illustration of an example operating environment 100 that is operable to employ the techniques described herein. The operating environment includes a computing device 102 having a processing system 104 and computer-readable media 106 that is representative of various different types and combinations of media, memory, and storage components and/or devices that may be associated with a computing device. The computing device 102 is further illustrated as including an operating system 108 and one or more device applications 110 that may reside on the computer-readable media (as shown), may be implemented at least partially by one or more hardware elements, and/or may be executed via the processing system 104. Computer-readable media 106 may include both “computer-readable storage media” and “communication media,” examples of which can be found in the discussion of the example computing system of FIG. 12. The computing device 102 may be configured as any suitable computing system and/or device that employ various processing systems 104 examples of which are also discussed in relation to the example computing system of FIG. 12.

In the depicted example, the computing device 102 includes a display device 112 that may be configured as a touchscreen to enable touchscreen and gesture functionality. The device applications 110 may include a display driver, gesture module, and/or other modules operable to provide touchscreen and gesture functionality enabled by the display device 112. Accordingly, the computing device may be configured to recognize input and gestures that cause corresponding operations to be performed.

For example, a gesture module may be configured to recognize a touch input, such as a finger of a user's hand 114 (or hands) as on or proximate to the display device 112 of the computing device 102 using touchscreen functionality. A variety of different types of gestures may be recognized by the computing device including, by way of example and not limitation, gestures that are recognized from a single type of input (e.g., touch gestures) as well as gestures involving multiple types of inputs. For example, can be utilized to recognize single-finger gestures and bezel gestures, multiple-finger/same-hand gestures and bezel gestures, and/or multiple-finger/different-hand gestures and bezel gestures. Further, the computing device 102 may be configured to detect and differentiate between gestures, touch inputs, grip characteristics, grip patterns, a stylus input, and other different types of inputs. Moreover, various kinds of inputs obtained from different sources, including the gestures, touch inputs, grip patterns, stylus input and inputs obtained through a mouse, touchpad, software or hardware keyboard, and/or hardware keys of a device (e.g., input devices), may be used in combination to cause corresponding device operations.

To implement grip-based device adaptation techniques, the computing device 102 may further include a skin driver module 116 and a touch-aware skin 118 that includes or otherwise makes uses of a plurality of skin sensors 120. The skin driver module 116 represent functionality operable to obtain and use various input from the touch-aware skin 118 that is indicative of grip characteristics, user identity, “on-skin” gestures applicable to the skin, skin and touchscreen combination gestures, and so forth. The skin driver module 116 may process and decode input that is received through various skin sensors 120 defined for and/or disposed throughout the touch-aware skin 118 to recognize such grip patterns, user identity, and/or “on-skin” gestures and cause corresponding actions. Generally, the skin sensors 120 may be configured in various ways to detect actual contact (e.g., touch) and/or near surface interaction (proximity detection) with a device, examples of which are discussed in greater detail below.

For example, grip characteristics and/or a grip pattern indicating a particular manner in which a user is holding or otherwise interacting with the computing device 102 may be detected and used to drive and/or enable grip dependent functionality of the computing device 102 associated with the grip. By way of example, on-screen input elements may be configured and displayed in a grip dependent manner. This may include but is not limited to locating input elements in a user interface based in part upon detected grip characteristics (e.g., hold locations, pattern, size, amount of pressure, etc.) Recognition and interpretation of touch input and gestures may also be adapted based on a detected grip. Further, gestures may be defined to take advantage of grip-aware functionality and cause grip dependent actions in response to the defined gestures. Moreover, grip characteristics may be employed to adjust recognition parameters for the device to selectively set sensor sensitivity in appropriate areas, reduce misrecognition, ignore input in areas deemed likely to produce inadvertent input according to the detected grip, and so forth. Details regarding these and other aspects of grip-based device adaptations are discussed in relation to the following figures.

Recognition of grip characteristics and other on-skin input through a touch-aware skin 118 is therefore distinguishable from recognition of touchscreen input/gestures (e.g., “on-screen” gestures) applied to a display device 112 as discussed above. The touch-aware skin 118 and display device 112 may be implemented as separate components through which on-skin and on-screen inputs may respectively be received independently of one another. In at least some embodiments, though, combinations of on-skin input and touchscreen input/gestures may be configured to drive associated actions. The touch-aware skin 118 and skin sensors 120 may be implemented in various ways, examples of which are discussed in relation to the following figures.

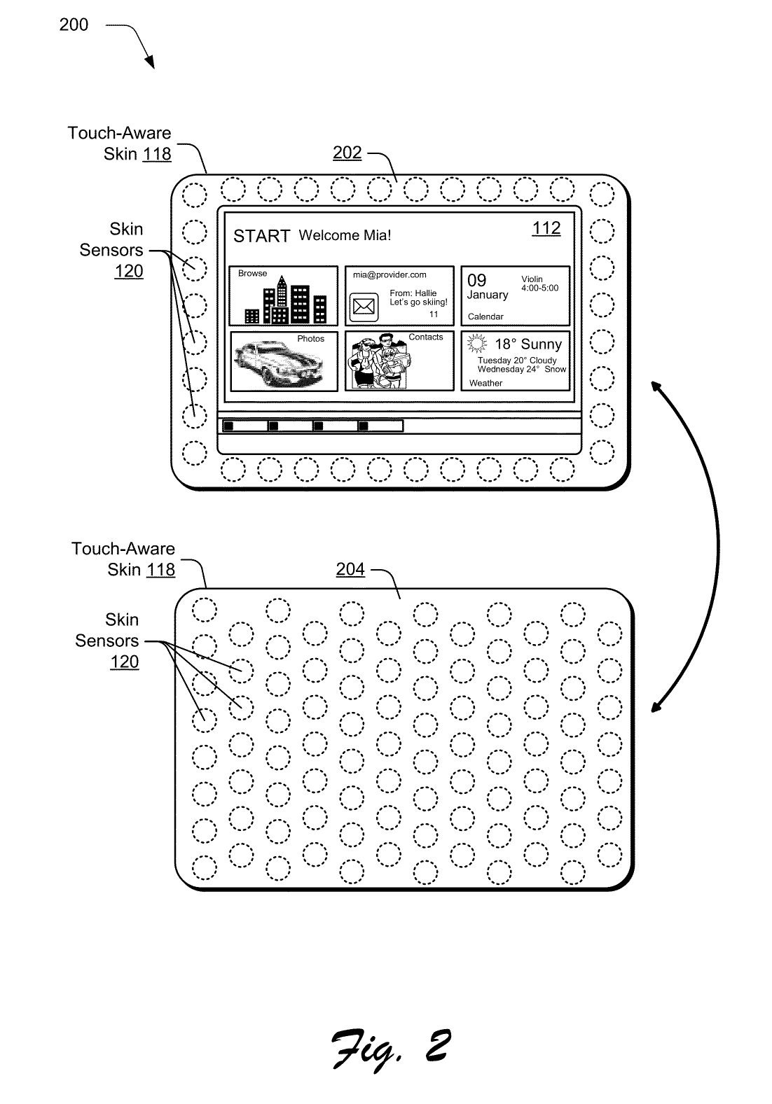

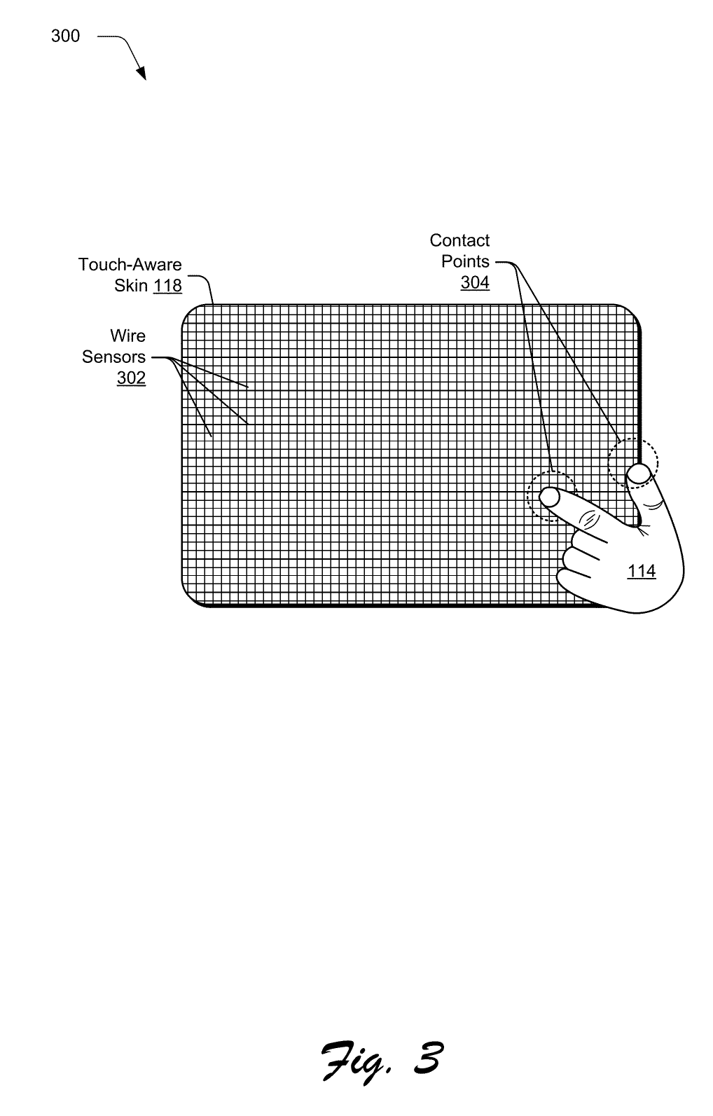

To further illustrate, details regarding a touch-aware skin are described in relation to example devices of FIG. 2 and FIG. 3. A touch-aware skin is generally configured to enable various on-skin input and/or gestures that are applied to the outer surfaces and/or housing of a computing device 102 that includes the touch-aware skin. Such on-skin input may be used in addition to, in lieu of, and/or in combination with other kinds of input including touchscreen input and input from various input devices.

In particular, FIG. 2 depicts generally at 200 an example computing device 102 of FIG. 1 that includes a touch-aware skin 118 having a plurality of skin sensors 120. FIG. 2 illustrates an array or grid of skin sensors 120 that are disposed at locations across the touch-aware skin 118. In particular, example surfaces 202 and 204 of the computing device 102 are depicted as having skin sensors 120 that are arranged across the surfaces in a pattern or grid. Naturally, coverage of skin sensors 120 may also extend across edges and other surfaces of a device, such skin sensors are associated with substantially the available surfaces of the device.

The touch-aware skin 118 can be configured as an integrated part of the housing for a device. The touch-aware skin 118 may also be provided as an attachable and/or removable add-on for the device that can be connected through a suitable interface, such as being incorporated with an add-on protective case. Further, the touch-aware skin 118 may be constructed of various materials. For example, the touch-aware skin 118 may be formed of rigid metal, plastic, touch-sensitive pigments/paints, and/or rubber. The touch-aware skin 118 may also be constructed using flexible materials that enable bending, twisting, and other deformations of the device that may be detected through associated skin sensors 120. According, the touch-aware skin 118 may be configured to enable detection of one or more of touches on the skin (direct contact), proximity to the skin (e.g., hovering just above the skin and/or other proximate inputs), forces applied to the skin (pressure, torque, sheer), deformations of the skin (bending and twisting), and so forth. To do so, a touch-aware skin 118 may include various different types and numbers of skin sensors 120.

The skin sensors 120 may be formed as physical sensors that are arranged at respective locations within or upon the touch-aware skin 118. For instance, sensors may be molded within the skin, affixed in, under, or on the skin, produced by joining layers to form a touch-aware skin, and so forth. In one approach, sensors may be molded within the touch-aware skin 118 as part of the molding process for the device housing or an external add-on skin device. Sensors may also be stamped into the skin, micro-machined around a housing/case, connected to a skin surface, or otherwise be formed with or attached to the skin. Skin sensors 120 may therefore be provided on the exterior, interior, and/or within the skin. Thus, the skin sensors 120 depicted in FIG. 2 may represent different locations associated with a skin at which different sensors may be physically placed.

In another approach, the skin may be composed of one or more continuous sections of a touch-aware material that are formed as a housing or covering for a computing device. A single section or multiple sections joined together may be employed to form a skin. In this case, the one or more continuous sections may be logically divided into multiple sensor locations that may be used to differentiate between different on skin inputs. Thus, the skin sensors 120 depicted in FIG. 2 may represent logical locations associated with a skin at which different sensors may be logically placed.

A variety of different kinds of skins sensors 120 are contemplated. Skin sensors 120 provide at least the ability to distinguish between different locations at which contact with the skin is made by a user's touch, an object, or otherwise. For example suitable skin sensors 120 may include, but are not limited to, individual capacitive touch sensors, wire contacts, pressure-sensitive skin material, thermal sensors, micro wires extending across device surfaces that are molded within or upon the surfaces, micro hairs molded or otherwise formed on the exterior of the device housing, capacitive or pressure sensitive sheets, light detectors, and the like. A single type of sensors may be used across the entire skin and device surfaces. In addition or alternatively, multiple different kinds of sensors may also be employed for a device skin at different individual locations, sides, surfaces, and/or other designated portions of the skin/device.

Some skin sensors 120 of a device may also be configured to provide enhanced capabilities, such as fingerprint recognition, thermal data, force and shear detection, skin deformation data, contact number/size distinctions, optical data, and so forth. Thus, a plurality of sensors and materials may be used to create a physical and/or logical array or grid of skin sensors 120 as depicted in FIG. 2 that define particular locations of the skin at which discrete on skin input may be detected, captured, and processed.

FIG. 3 depicts generally at 300 another example computing device 102 of FIG. 1 that includes a touch-aware skin 118 having a plurality of skin sensors 120. In this example, the skin sensors are configured as wire sensors 302 disposed across surfaces of the device to form a grid. The wire sensors 302 may be molded into a mylar, rubber, or other suitable device housing or case. As depicted, the wires establish a grid upon which various contacts points 304 from a user's hand 114 (or other objects) may be detected and tracked. For instance, the grid may be calibrated to create a defined coordinate system that a skin driver module 116 can recognize to process inputs and cause corresponding actions. Thus, skin sensors 120, such as the example wire sensors 302, can be used to determine particular grip patterns and/or gestures applied to the skin of a device that drive particular operations and/or selectively enable particular device functionality.

Having described an example operating environment, consider now a discussion of some example implementation details regarding techniques for grip-based device adaptations in one or more embodiments.

Grip-Based Device Adaptation Details

The following discussion describes grip-based device adaptation techniques, user interfaces, and interaction scenarios that may be implemented utilizing the previously described systems and devices. Aspects of each of the procedures described herein may be implemented in hardware, firmware, software, or a combination thereof. The procedures are shown as a set of blocks that specify operations performed by one or more devices and are not necessarily limited to the orders shown for performing the operations by the respective blocks. In portions of the following discussion, reference will be made to the environment 100 and example devices 200 and 300 of FIGS. 2 and 3, respectively. In at least some embodiments, the procedures may be performed by a suitably configured computing device, such as the example computing device 102 of FIG. 1 that includes or otherwise make use of a skin driver module 116 to control a touch-aware skin 118.

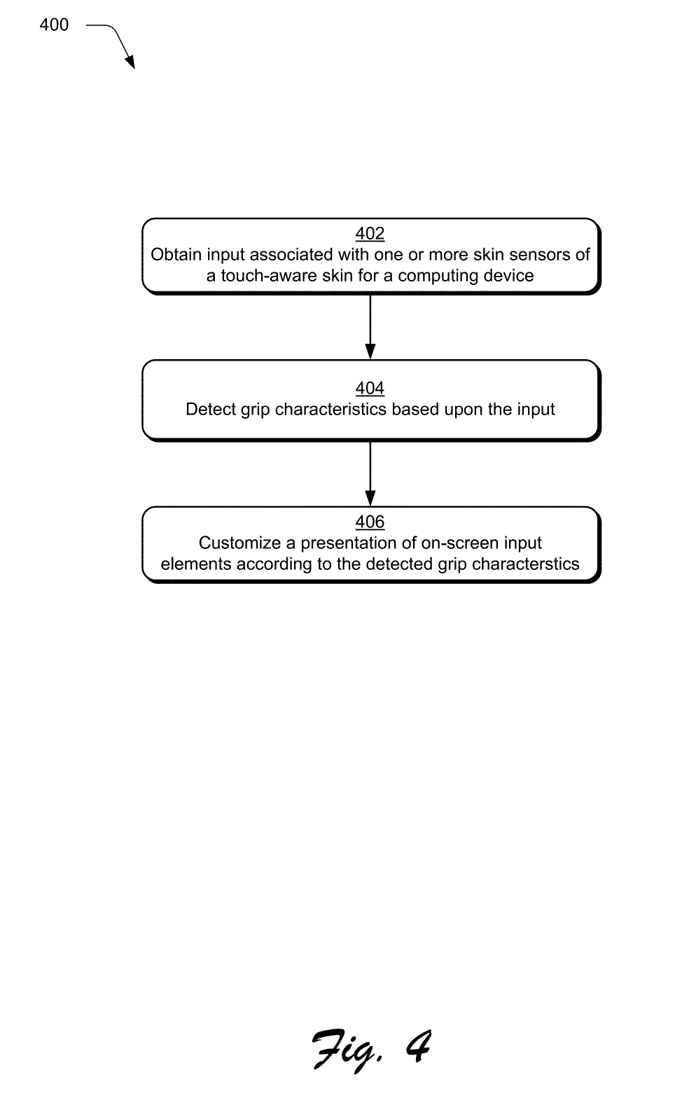

FIG. 4 depicts an example procedure 400 in which grip characteristics for a device are used to customize on-screen input elements. Input is obtained that is associated with one or more skin sensors of a touch-aware skin for a computing device (block 402). The input may be obtained through various sensors associated with a device. For example, a skin driver module 116 may obtain input via various skin sensors 120 of a touch-aware skin 118 as described previously. The input may correspond to contact points by a user or object upon or proximate to the surfaces of the device. The contact may include contacts on the skin itself as well as on a touchscreen display surface. The skin driver module 116 may be configured to detect, decode, and process input associated with the touch-aware skin to adapt the behavior/functionality of the device accordingly.

In particular, grip characteristics are detected based upon the input (block 404). A variety of different grip characteristics that are detectable by a skin driver module 116 may be defined for a device. In general, the grip characteristics are indicative of different ways in which a user may hold a device, rest a device against an object, set a device down, orient the device, place the device (e.g., on a table, in a stand, in a bag, etc.), apply pressure, and so forth. Each particular grip and associated characteristics of the grip may correspond to a particular pattern of touch interaction and/or contact points with the skin at designated locations. The system may be configured to recognize different respective grip patterns and locations of grips/contacts and adapt device behaviors accordingly. A variety of grip characteristics for contacts can be used to define different grip patterns including but not limited to the size, location, shape, orientation, applied pressure (e.g., hard or soft), and/or number of contact points associated with a user's grip of a device, to name a few examples.

By way of example, a user may hold a tablet device with one hand such that the user's thumb contacts the front “viewing” surface and the user's fingers are placed behind the device for support. Holding the tablet device in this manner creates a particular combination of contact points that may be defined and recognized as one grip pattern. Likewise holding the device with two hands near a bottom edge produces another combination of contact points that may defined as a different grip pattern. A variety of other example grip patterns are also contemplated. Different grip patterns may be indicative of different interaction contexts, such as a reading context, browsing context, typing context, media viewing context, and forth. A skin driver module 116 may be encoded with or otherwise make use of a database of different grip pattern definitions that relate to different ways in which a device may be held or placed. Accordingly, the skin driver module 116 may reference grip pattern definitions to recognize and differentiate between different interaction contexts for user interaction with a computing device.

A presentation of on-screen input elements is customized according to the detected grip characteristics (block 406). As mentioned, the skin driver module 116 may be configured to associate different grip patterns with different contexts for interaction with the device. The different contexts may be used to cause corresponding actions such as customizing device operation, adapting device functionality, enabling/disabling features, optimizing the device and otherwise selectively performing actions that match a current context. Thus, the behavior of a device may change according to different contexts.

In other words, different grip patterns may be indicative of different kinds of user and/or device activities. For instance, the example above of holding a tablet device may be associated with a reading context. Different types of holds and corresponding grip patterns may be associated with other contexts, such as watching a video, web-browsing, making a phone call, and so forth. The skin driver module 116 may be configured to support various contexts and corresponding adaptations of a device. Accordingly, grip patterns can be detected to discover corresponding contexts, differentiate between different contexts, and customize or adapt a device in various ways to match a current context, some illustrative examples of which are described just below.

For instance, grip position can be used as a basis for modifying device user interfaces to optimize the user interfaces for a particular context and/or grip pattern. This may include configuring and locating on-screen input elements in accordance with a detect grip, grip characteristics, and/or an associated interaction context. For example, the positions of windows, pop-ups, menus, and command elements may be moved depending on where a device is being gripped. Thus, if a grip pattern indicates that a user is holding a device in their left hand, a dialog box that is triggered may appear opposite the position of the grip, e.g., towards the right side of a display for the device. Likewise, a right-handed or two-handed grip may cause corresponding adaptations to positions for windows, pop-ups, menus and commands. This helps to avoid occlusions and facilitate interaction with the user interface by placing items in locations that are optimized for grip. Thus, informational elements may be placed in a manner that avoids occlusion. On-screen input elements designed for user interaction may be exposed at locations that are within reach of a user's thumb or fingers based on an ascertained grip and/or context.

In one particular example, configuration and location within a user interface of a soft, on-screen keyboard may be optimized based on grip position. For example, the location and size of keyboard may change to match a grip pattern. This may include altering the keyboard based on orientation of the device determined at least partially through a grip pattern. In addition, algorithms used in a text input context for keyboard key hits, word predictions, spelling corrections, and so forth may be tuned according to grip pattern. This may involve adaptively increasing and or decreasing the sensitivity of keyboard keys as a grip pattern used to interact with the device changes. Thus, the keyboard may be configured to adapt to a user's hand position and grip pattern. This adaptation may occur automatically in response to detection of grip characteristics and changes to hand positions.

Grip patterns determined through skin sensors can also assist in differentiating between intentional inputs (e.g., explicit gestures) and grip-based touches that may occur based upon a user's hand positions when holding a device. This can occur by selectively changing touchscreen and/or “on-skin” touch sensitivity based upon grip patterns at selected locations. For instance, sensitivity of a touchscreen can be decreased at one or more locations proximate to hand positions (e.g. at, surrounding, and/or adjacent to determined contact points) associated with holding a device and/or increased in other areas. Likewise, skin sensor sensitivity for “on-skin” interaction can be adjusted according to a grip pattern by selectively turning sensitivity of one or more sensors up or down. Adjusting device sensitivities in this manner can decrease the chances of a user unintentionally triggering touch-based controls and responses due particular to hand positions and/or grips.

In another approach, different grip patterns may be used to activate different areas and/or surfaces of a device for touch-based interaction. Because sensors are located on multiple different surfaces, the multiple surfaces may be used individually and/or in varying combinations at different times for input and gestures. A typical tablet device or mobile phone has six surfaces (e.g., front, back, top edge, bottom edge, right edge, and left edge) which may be associated with sensors and used for various techniques described herein. Additionally, different surfaces may be selectively activated in different contexts. Thus, the touch-aware skin 118 enables implementation of various “on-skin” gestures that may be recognized through interaction with the skin on any one or more of the device surfaces. Moreover, a variety of combination gestures that combine on-skin input and on-screen input applied to a traditional touchscreen may also be enabled for a device having a touch-aware skin 118 as described herein.

Consider by way of example a default context in which skin sensors on the edges of a device may be active for grip sensing, but may be deactivated for touch input. One or more edges of the device may become active for touch inputs in particular contexts as the context changes. In one example scenario, a user may hold a device with two hands located generally along the short sides of the device in a landscape orientation. In this scenario, a top edge of the device is not associated with grip-based contacts and therefore may be activated for touch inputs/gestures, such as enabling volume or brightness control by sliding a finger along the edge or implementing other on-skin controls on the edge such as soft buttons for a camera shutter, zoom functions, pop-up menu toggle, and/or other selected device functionality. If a user subsequently changes their grip, such as to hold the device along the longer sides in a portrait orientation, the context changes, the skin driver module 116 detects the change in context, and the top edge previously activated may be deactivated for touch inputs/gestures or may be switched to activate different functions in the new context.

In another example scenario, a user may interact with a device to view/render various types of content (e.g., webpages, video, digital books, etc.) in a content viewing context. Again, the skin driver module 116 may operate to ascertain the context at least in part by detecting a grip pattern via a touch-aware skin 118. In this content viewing context, a content presentation may be output via a display device of the computing device that is located on what is considered the front-side of the device. The back-side of the device (e.g., a side opposite the display device used to present the content) can be activated to enable various “on-skin” gestures to control the content presentation. By way of example, a user may be able to interact on the back-side to perform browser functions to navigate web content, playback functions to control a video or music presentation, and/or reading functions to change pages of digital book, change viewing settings, zoom in/out, scroll left/right, and so forth. The back-side gestures do not occlude or otherwise interfere with the presentation of content via the front side display as with some traditional techniques. In another example a back-side gesture enables selective display of an on-screen keyboard. Naturally, device edges and other surfaces may be activated in a comparable way and/or in combination with backside gestures in relation to various different contexts. A variety of other scenarios and “on-skin” gestures are also contemplated.

As mentioned, skins sensors 120 may be configured to detect interaction with objects as well as users. For instance, contact across a bottom edge may indicate that a device is being rested on a user's lap or a table. Particular contacts along various surfaces may along indicate that a device has been placed into a stand. Thus, a context for a device may be derived based on interaction with objects. The context may include a determination of finger and palm positions as well as size of touch contexts. This information may be used to adapt interactions for particular hand positions, sizes, and specific users/groups of users resolved based on hand position. In at least some embodiments, object interactions can be employed as an indication to contextually distinguish between situations in which a user actively uses a device, merely holds the device, and/or sets the device down or places the device in a purse/bag. Detection of object interactions and corresponding contexts can drive various responsive actions including but not limited to device power management, changes in notification modes for email, text messages, and/or phone calls, and display and user interface modifications, to name a few examples.

Thus, if the skin driver module 116 detects placement of a device on a table or night stand this may trigger power management actions to conserve device power. In addition, this may cause a corresponding selection of a notification mode for the device (e.g., selection between visual, auditory, and/or vibratory modes).

Further, movement of the device against a surface upon which the device is placed may also be detected through the skin sensors. This may enable further functionality and/or drive further actions. For example, a mobile device placed upon a desk (or other object) may act like a mouse or other input control device that causes the device display and user interface to respond accordingly to movement of the device on the desk. Here, the movement is sensed through the touch-aware skin. The mobile device may even operate to control another device to which the mobile device is communicatively coupled by a Bluetooth connection or other suitable connection.

In another example, device to device interactions between devices having touch-aware skins, e.g. skin to skin contact, may be detected through skin sensors and used to implement designated actions in response to the interaction. Such device to device on-skin interactions may be employed to establish skin to skin coupling for communication, game applications, application information exchange, and the like. Some examples of skin to skin interaction and gestures that may be enabled including aligning devices in contact end to end to establish a peer to peer connection, bumping devices edge to edge to transfer photos or other specified files, rubbing surfaces together to exchange contact information, and so forth.

It should be noted again that grip patterns ascertained from skin sensors 120 may be used in combination with other inputs such as touchscreen inputs, an accelerometer, motion sensors, multi-touch inputs, traditional gestures, and so forth. This may improve recognition of touches and provides mechanisms for various new kinds of gestures that rely at least in part upon grip patterns. For example, gestures that make used of both on-skin detection and touchscreen functionality may be enabled by incorporating a touch-aware skin as described herein with a device.

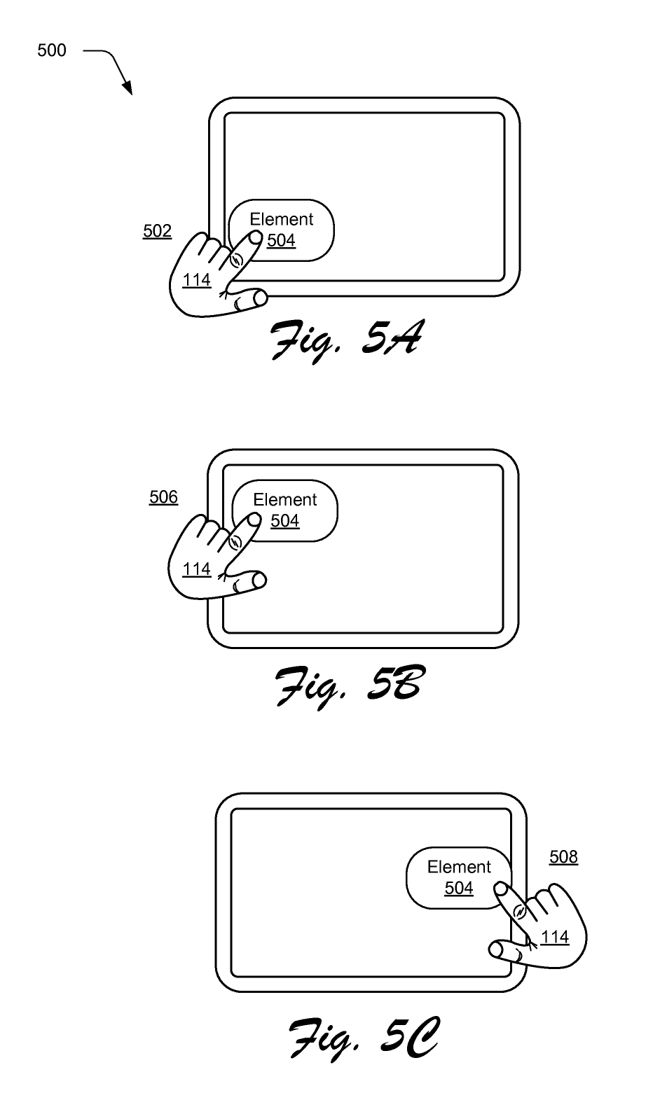

To further illustrate, some examples of adapting on-screen elements based on grip characteristics are depicted and described in relation to FIGS. 5-7. In particular, FIG. 5 depicts generally at 500 representative examples in which at least a location at which an on-screen input element is displayed may be adapted based upon grip characteristics. In an implementation, a location for an on-screen input element may depend at least in part upon a location(s) ascertained for a user's grip. The location may further be dependent upon other grip characteristics that are recognized by the system, such as a number of contacts, a grip pattern, pressure applied, an ascertained interaction context, and so forth. In FIG. 5a for instance, a user's hand 114 is represented as holding a device at a location 502 at a lower left corner of the device. Based on detection of the grip and/or location 502 in the manner discussed herein (e.g., using a touch-aware skin), an element 504 rendered within a user interface is adapted accordingly. In the example of FIG. 5a, the location of the element 504 corresponds to the location 502 that is detected. In other words, the element 504 is positioned and/or aligned based upon the location 502. In addition to adapting the location, the element 504 may also be configured in various other ways based on detected grip characteristics. By way of example, adaptive configuration of an element based upon grip characteristics may include but is not limited to adaptations to element size, touch behavior, hit target size, location/position, element type or mode (e.g., select between alternative elements based on grip), appearance (e.g., color, transparency, effects, shading, etc.), to name a few examples.

FIGS. 5b and 5c represent additional examples of positioning of the element 504 at different locations according to grip characteristics. In the example of FIG. 5b, the user's hand 114 is represented as holding a device at a location 506 at along a left edge of the device. Accordingly, the location of the element 504 corresponds to the location 506 along the left edge that may be detected using various sensors. In FIG. 5c, a user's grip has switched such that a user's hand 114 is now depicted at a location 508 along a right edge of the device. Now, the location of the element 504 corresponds to the location 508 along the right edge. Although the examples of FIG. 5 show static adaptations to an element 504 based on grip characteristics, adaptations may occur and be represented dynamically as a user's adjusts their grip. Thus, the element 504 may track movements of a user's hand around the device such that the element 504 may move around the display in response to grip adjustments and repositioning.

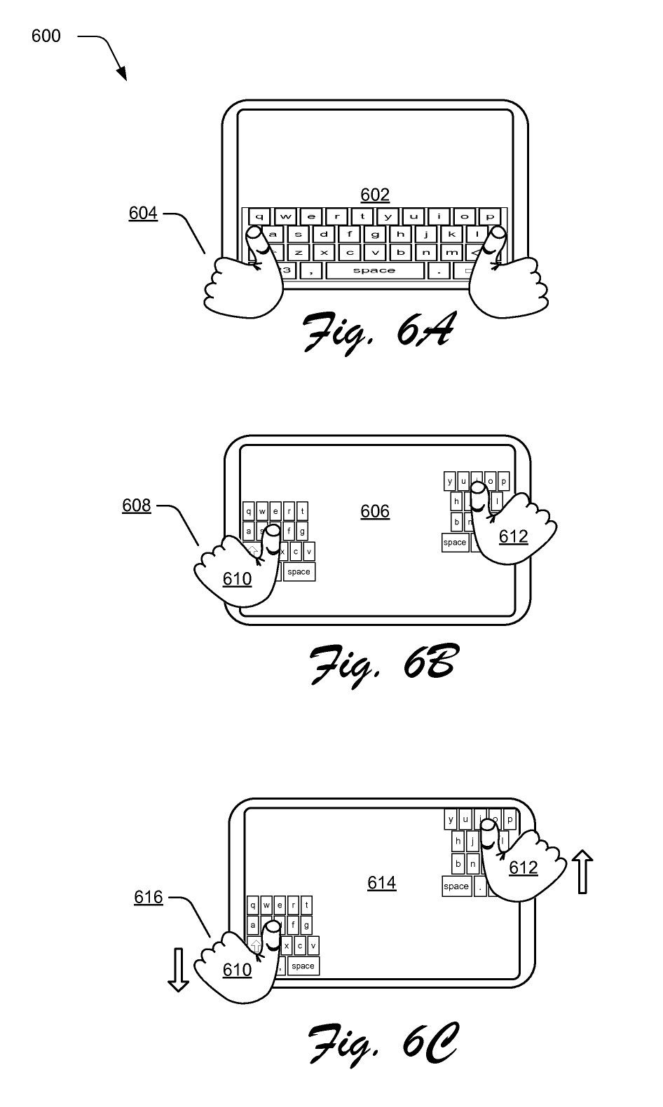

FIGS. 6a, 6b, 6c depict generally at 600 representative examples in which an on-screen element configured as a keyboard may be adapted based upon grip characteristics. At least a location of the keyboard may change based upon detected grip characteristics. Additionally, a particular type of keyboard to display may be selected from among multiple available options based upon grip characteristics. In one example, multiple available options may include at least a split keyboard and a contiguous keyboard, as shown in the figures. Further, configuration of the keyboard may also be adapted based on the grip characteristics. As mentioned, the location and size of keyboard may change to match a grip pattern. Further, algorithms used in a text input context for keyboard key hits, word predictions, spelling corrections, and so forth may also be tuned according to grip pattern. Thus, the keyboard may be configured to adapt to a user's hand position and grip pattern automatically in response to detection of grip characteristics and changes to hand positions.

To illustrate this concept, FIG. 6a depicts an arrangement 602 of an on-screen keyboard that may be displayed in connection with a grip 604. Here, the grip 604 is represented as holding the device with two hands along a bottom, long edge of the device. The grip 604 may be resolved using skin sensors and techniques as described herein. In this example, the arrangement 602 the on-screen keyboard is shown as a contiguous keyboard that is located generally in the bottom portion of a display spanning across the bottom, long edge. Thus, the arrangement 602 and location of the contiguous keyboard corresponds to a detected grip/grip characteristics that indicate holding of the device with two hands along the bottom, long edge.

As noted, the configuration of the keyboard including the arrangement and location may adapt based on the grip. In FIG. 6b for example, an arrangement 606 of the on-screen keyboard that may be displayed responsive to detection of a grip 608 is depicted. Here, the grip 608 is represented with a user's left hand 610 and right hand 612 staggered on short edges of the device. In this case, the on-screen keyboard may be adapted into a split keyboard arrangement a shown. The split keyboard arrangement presents the keyboard in multiple, split portions such that the user may interact with different keys and functions with different hands. In this arrangement, occlusion of content rendered in the center portion of the display by the keyboard may be avoided. Notably, the split portions of the keyboard on respective edges may be individually positioned and aligned with corresponding hands on the edges. Thus, a portion of the keyboard on the right edge is located closer to the top edge based on the right hand position and a portion of the keyboard on the left edge is located closer to the bottom edge based on the left hand position. Further, hit targets and touch sensitivities may be adjusted based on detected hand positions and reachable areas in the arrangement.

The split keyboard portions may further be configured to individually track hand positions. The spilt portions of the keyboard may therefore respond and move to different locations independently of one another. For instance, if a user slides or otherwise moves their right hand up/down the right edge, the right portion of the split keyboard may track this motion while the left portion of the split keyboard stays in place, and vice versa. Naturally, if both hands are repositioned at the same time, then both portions of the split keyboard may respond accordingly to independently follow movement of corresponding hands.

To illustrate, FIG. 6c depicts an arrangement 614 of the on-screen keyboard that may be displayed responsive to detection of a grip 616. Here the grip 616 represents repositioning of hand positions for the grip 608 illustrated in FIG. 6b to positions at diagonally opposed corners. This may occur for example by sliding the right hand up and the left hand down respective edges of the device. In response to this repositioning, the left and right portions of the split keyboard may track the motion of the hands. As shown in FIG. 6a, the left and right portions of the split keyboard are now relocated at diagonally opposed corners of the display in accordance with the grip 616.

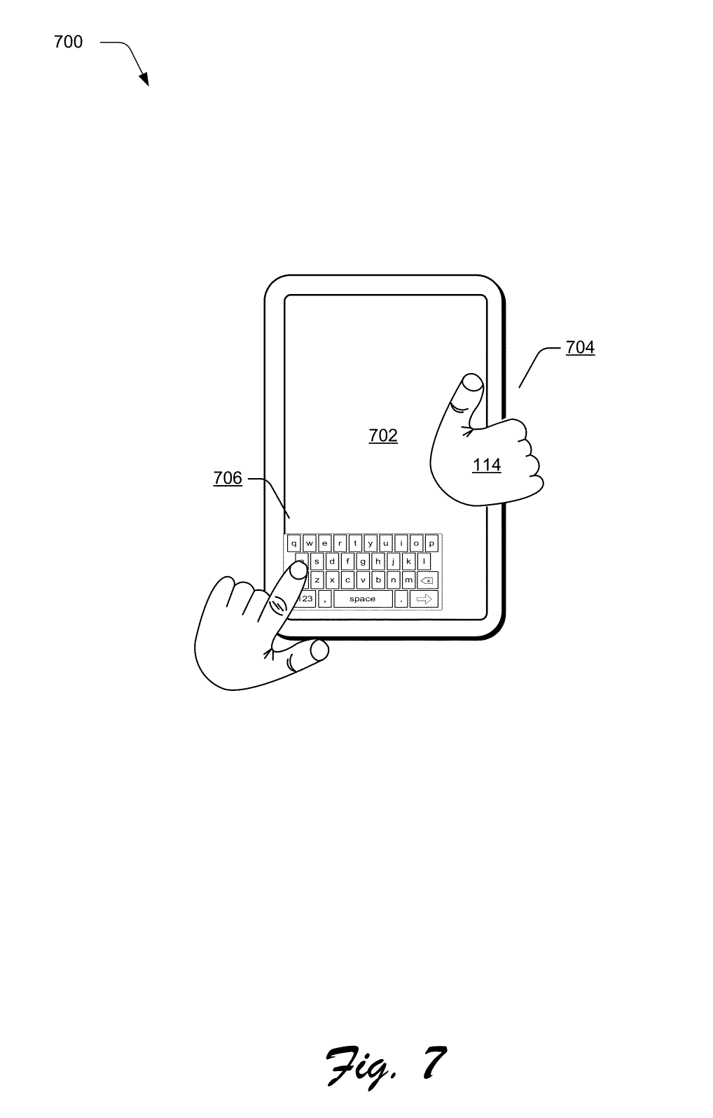

FIG. 7 depicts generally at 700 another arrangement 702 of the on-screen keyboard that may be displayed responsive to detection of a grip 704. In this case, the grip 704 corresponds to a single hand hold of the device along a long edge of the device. The grip 704 may be associated with a landscape orientation of the device. The grip 704 may be also be associated with a particular interaction context ascertained based at least in part upon the grip characteristics. For example, a reading context or viewing context may be ascertained in which it may be inferred that the user is reading a book, viewing web content, viewing media content, and so forth. In this case, the on-screen keyboard may again be adapted to the grip 704 that is detected. In addition or alternatively, the on-screen keyboard may be optimized for the particular interaction context.

In the depicted example, the on-screen keyboard is located generally at a lower corner of the device on an opposite side of the device from a location of the grip 704. In an implementation, the keyboard may be sized to avoid occlusion of the keyboard by the gripping hand. Thus, in the example of FIG. 7 the keyboard is sized such that the keyboard partially spans across the width of the device (e.g., partially across the length of the bottom edge). This arrangement may be selected to facilitate input by the non-gripping hand using a single finger (e.g., “hunt and peck”) or otherwise adapt in accordance with a particular interaction context associated with the grip.

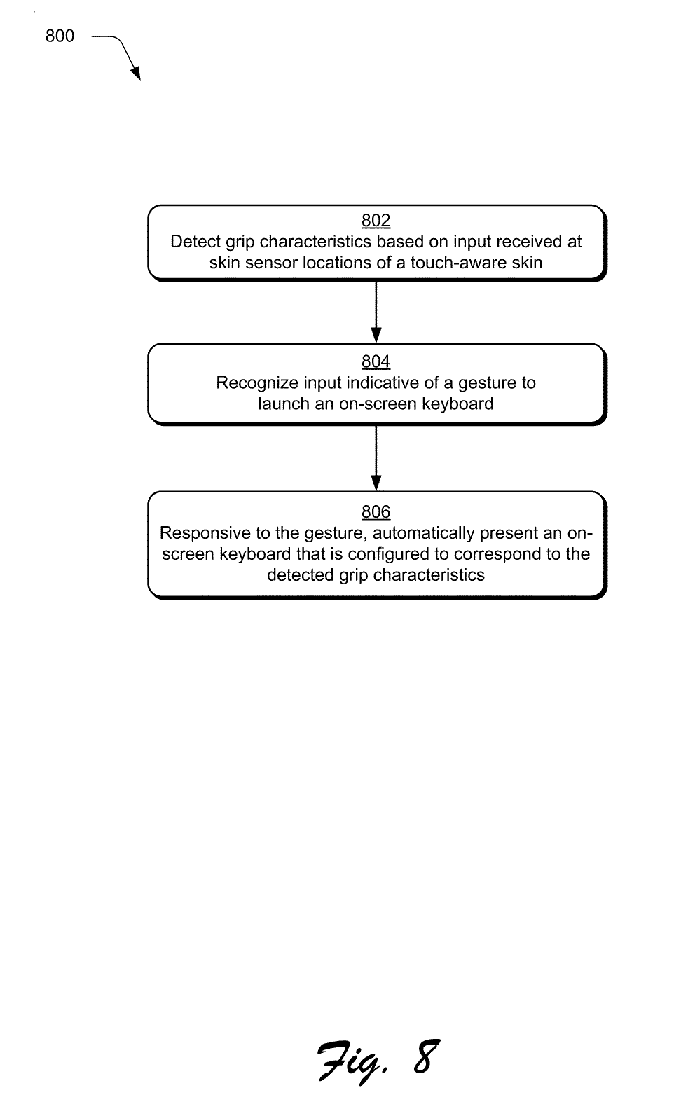

FIG. 8 depicts an example procedure 800 in which an on-screen gesture to launch an on screen keyboard is recognized. As mentioned, a touch aware skin described herein may enable various “on-skin” gestures. In an implementation, one or more gestures may be defined that may be used to control launching and/or closing of an on-screen keyboard. Such gestures may be employed by a user to cause the on-screen keyboard to appear and disappear on demand. When a user initiates display of the keyboard via an appropriate gesture, the location and configuration of the on-screen keyboard may be adapted to detected grip characteristics in the manner described above and below.

To do so, grip characteristics are detected based upon input received at skin sensor locations of a touch aware skin (block 802). Detection of various grip characteristics may occur in the manner described previously. The sensor locations may correspond to physical sensors of a touch-aware skin 118. Once grip characteristics are detected, various actions can be taken to customize a device and the user experience to match the detected grip, some examples of which were previously described. Thus, grip characteristics may be detected and used in various ways to modify the functionality provided by a device at different times. This may include locating and configuring on-screen elements, such as a keyboard, in accordance with detected grip characteristics.

Input indicative of a gesture to launch an on-screen keyboard is detected (block 804). Responsive to the gesture, an on-screen keyboard that is configured to correspond to the detected grip characteristics is automatically presented (block 806). Thus, the detected gesture is configured to initiate a launch of the keyboard to present the keyboard via a user interface for user interaction. Moreover, the keyboard may be adapted in various ways in accordance with grip characteristics detected using sensor arrangements and techniques discussed herein. For example, the type of keyboard employed may change depending upon grip as discussed in relation to FIGS. 6 and 7. Further, positioning of the keyboard within a UI may change depending upon grip and/or may track hand position as discussed in relation to FIG. 5. Various other grip-dependent adaptations of the keyboard may also be implemented when the keyboard is launched, examples of which were previously described.

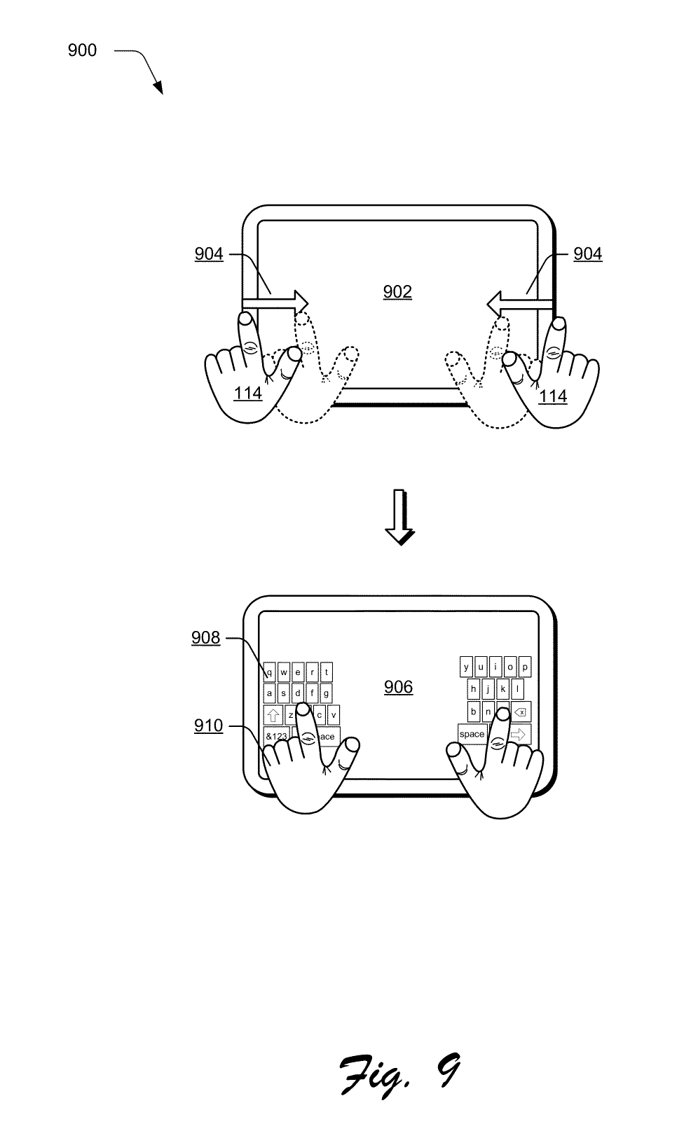

One particular example of a gesture to launch an onscreen keyboard is depicted in FIG. 9 generally at 900. In this example, an arrangement 902 of a user interface for a device is depicted in which an on-screen keyboard is hidden or otherwise does not appear. A gesture 904 may be defined to facilitate launch of the on-screen keyboard on demand by a user. As represented in FIG. 9, the gesture 904 involves a double swiping motion inwards towards the center of the device with both hands. The swiping may occur from opposite edges of the device, which in this example are illustrated as short edges of the device. Naturally, swiping in from the long edges to launch a keyboard may define another launch gesture for use in a portrait orientation of the device in a comparable manner. The gesture may be performed using thumbs of each hand or a single finger of each hand on the edges, bezel, and/or display of a device. Thus, recognition of the gesture may involve detecting an inward swiping motion towards the center of a display in relation to at least one contact point associated with each of a user's hands. Alternatively, the gesture 904 may be defined using two or more fingers per hand (e.g., multiple contacts per hand). In this case, multiple finger swipes from both sides may be recognized to launch the keyboard. In an implementation, swiping outward toward the edges in a reverse manner (e.g., opposite motion relative to the launch gesture) may define a close gesture to close, hide, or otherwise cause the displayed keyboard to disappear from the user interface.

The launch gesture causes a corresponding on-screen keyboard to appear within the interface. The location and configuration of the on-screen keyboard is dependent upon the detected grip characteristics. Thus, in FIG. 9 an arrangement 906 of the user interface that includes a split keyboard 908 is depicted as being displayed responsive to the gesture 904. The type of keyboard, location, and other configuration aspects are selected based upon the location and other characteristics of the user's grip 910. In this example, two individual portions of the split keyboard 908 are positioned and aligned according to the user's grip 910 to facilitate text input with two hands. The two individual portions may independently track movement/repositioning of respective hands to which they are aligned as discussed previously. Different keyboard arrangements may be presented for different hand positions as discussed in relation to the examples of FIGS. 6 and 7. Thus, a launch gesture as shown in FIG. 9 may be defined to launch a keyboard that is configured in a grip-dependent manner.

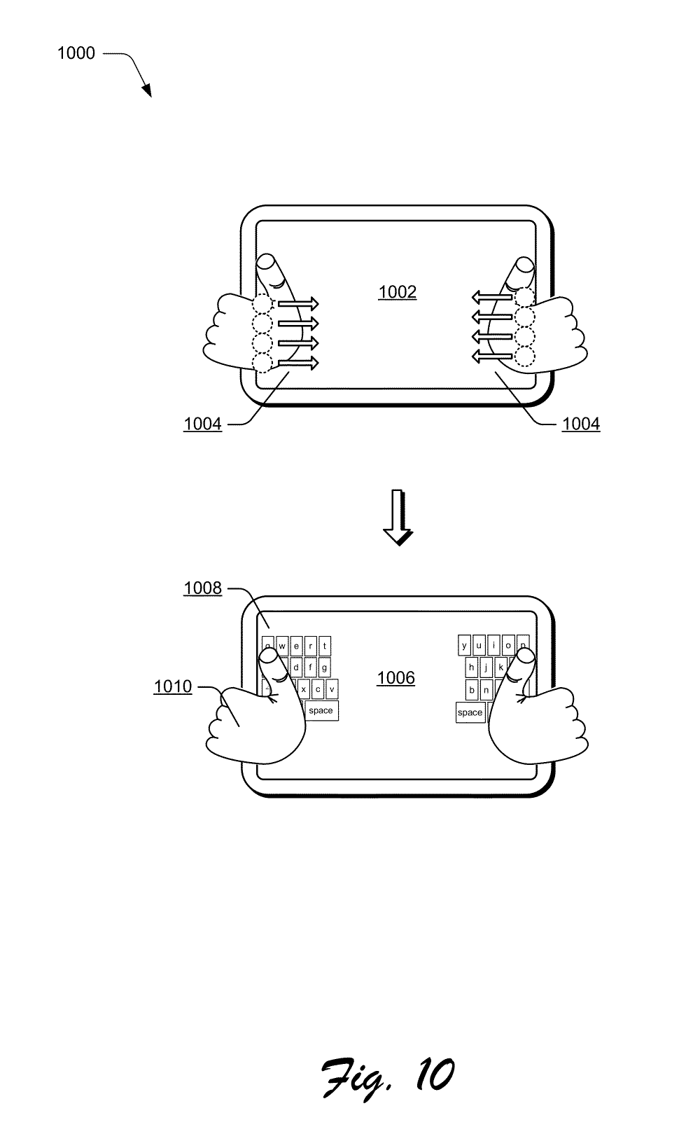

Another example of a gesture that may be employed to launch an on-screen keyboard is depicted in FIG. 10 generally at 1000. In this example, an arrangement 1002 of a user interface is shown without a displayed keyboard. Following input and recognition of a gesture 1004, an arrangement 1006 of the user interface may be output that includes a split keyboard 1008. Again the split keyboard 1008 is configured in accordance with the location and other characteristics of the user's grip 1010. In response to the gesture, the keyboard may be animated to slide-out from the edges upon which the user grips the device. Other transitions and animations to make the keyboard appear and disappear are also contemplated.

As represented in FIG. 10, the gesture 1004 is a “back-side” gesture that may be implemented on a back-side of the device. The gesture 1004 may involve a double swiping motion inwards towards the center of the device with both hands, this time on the back-side of the device (e.g., opposite a display). The back-side gestures may be enabled by an appropriate skin sensor arrangement, some examples of which were discussed in relation to FIGS. 2 and 3. The swiping may occur generally perpendicular to the two edges of the device upon which the user grips the device and parallel to the other two edges. Thus, recognition of the gesture may involve detecting an inward swiping motion on the back-side of the device in relation to multiple contact points associated with a user's grip. In the depicted example, a global swipe inward of four fingers of each hand on the back-side is represented. The gesture 1004 to launch an on-screen keyboard from the back-side though may also be defined with fewer than four fingers, with a single hand gesture, and so forth.

Other gestures and corresponding responses are also contemplated. In one example, a single hand gesture (swipe with fingers of one hand) may be used to launch a split keyboard and a double hand gesture may (swipe with fingers of both hands) may be used to launch a full keyboard. In addition or alternatively, a sweeping motion of a user's thumbs back and forth (e.g., like windshield wipers) on the edges and/or display of the device may be employed as a keyboard launch gesture. Another example involves tapping on the back-side using a designated number and pattern of taps to launch the keyboard. Some further examples of gestures that may be associated with launch of a on-screen keyboard include but are not limited to double tapping with multiple fingers on the back-side, sliding a finger along a particular edge on the front or back side, tapping a designated corner on the back-side, and so on.

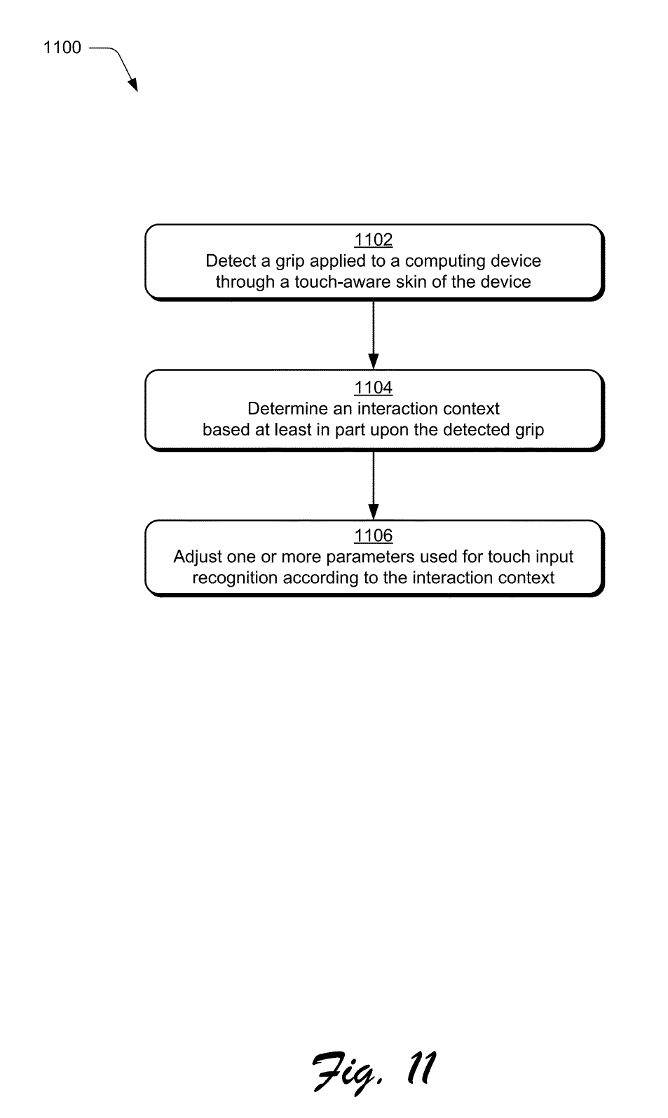

FIG. 11 depicts an example procedure 1100 in which parameters for touch input recognition are adjusted based upon a detected grip. A grip applied to a computing device is detected through a touch-aware skin of the computing device (block 1102). An interaction context is determined based at least in part upon the detected grip (block 1104). One or more parameters used for touch input recognition are adjusted according to the interaction context (block 1104).

Once grip characteristics are detected, various actions can be taken to customize a device and the user experience to match the detected grip, some examples of which were previously described. This may include selectively turning various functionality of the device on or off. This may also include adjusting the parameters used for touch input recognition according to the grip characteristics and/or a corresponding interaction context. The system may be further configured to detect user specific information such as finger sizes, hand sizes, hand orientation, left or right handedness, grip patterns, and position of the grip and use this user specific information to customize grip-based device adaptations in a user-specific manner for individual users and/or categories of users (e.g., adult/child, men/women, etc.). In one particular example, user specific information includes the amount of pressure that is applied by the grip. Generally, different user may apply different amounts of pressure when holding a device. The pressure taken alone or in combination with other grip characterizes may be used to adapt sensitivity of input elements (e.g., on-screen or on-skin buttons, keyboard keys, etc.) and/or gesture recognition parameters. Grip pressure may be the pressure that is determine for individual sensors. In addition or alternatively, pressure differential between groups of sensors may be measure an employed for adaptations. For instance, a correlation between pressure force on a touch screen and pressure on the backside (or grip side) of the device may be determined. Sensitivities for gesture detection, touch responsiveness, and button placement and responsiveness, may be adapted accordingly

In general, at least some functionality of the device may be dependent upon a corresponding grip pattern. For example, touchscreen functionality and/or particular touchscreen gestures may be adjusted based on a grip pattern. This may include changing touch sensitivity in different areas of the device, enabling or disabling touchscreen gestures based on a context associated with a grip pattern, activating combination gestures that are triggered by a combination of grip-based input (e.g., on-skin input) and touchscreen gestures, and so forth. Thus, grip patterns may be used in various ways to modify the functionality provided by a device at different times. Logical sensor locations may also be defined on a sensor grid of a touch aware, such as the example shown and discussed in relation to FIG. 3. The skin sensors as well as sensors associated with a touchscreen may be selectively turned on or off depending upon the grip pattern. Parameters used for touch input recognition that may be adjusted include, speed/velocity of input, timing parameters, size of contact, length, number of sensor points, applied pressure, and so forth. Combinations of these parameters may be used to define different gestures with threshold values for the parameters used as a basis for recognizing the gestures and triggering corresponding actions. Accordingly, the threshold values for the parameters and/or the responsiveness/sensitivity of sensors in particular areas of the device may be adapted based upon the grip and interaction context.

Consider an example in which a user is holding a device with two hands for typing input as shown in FIG. 6a. In this scenario, the skin driver module 116 may interpret detected grip characteristics as being associated with a typing context. Accordingly, sensitively of areas determined to be reachable by a user's thumbs may be increased with respect to typing input on the onscreen keyboard. The sensitivity and/or threshold levels to trigger some gestures may be decreased to reduce the chance that input for typing is misrecognized as a gesture. In addition or alternatively, sensors in areas of the screen and skin that are interpreted as grip points may also be turned off or desensitized to prevent inadvertent input and misrecognition. For instance, regions associated with a user's palm and sides of the hand may be identified based on the grip characteristics and sensors in these areas may be adjusted accordingly to prevent misrecognition. The skin sensors may further enable tracking the placement and/or contact points of each finger to understand how a user is gripping the device and how the grip may change over time. Changes to sensor and gesture sensitivities may change according to the tracked hand position and/or a corresponding interaction context. This facilitate selective adjustments of particular sensors and regions to ignore certain input in areas likely to produce inadvertent/unintentional contact and thereby minimize false positives.

In another example, a reading context may be identified based on grip characteristics alone or in combination with further context information, such as the device orientation, an application that is active, content identification, and so forth. In the reading context, a user may grip the device in one hand and use the other hand to effectuate input for page turning gestures, typing input, content/menu control, and so forth. A grip associated with the reading context may be similar to the example grip arrangement shown in FIG. 7. In this scenario, sensitivity of sensors at and around the location of grip 704 (e.g., sensors proximate to the gripping hand) may be decreased to prevent inadvertent or unintentional input from the gripping hand that may be misinterpreted. At the same time, sensitivity for touch/gestures may be increased in areas expected to be employed for page turning gestures, text input, and other input using the non-gripping hand. For instance, in the example of FIG. 7, the sensitivity for typing and gestural input may be boosted along the left edge and/or in the lower left corner of the device where the on-screen keyboard is depicted to facilitate typing and gesture recognition.

A variety other examples of adjusting parameters used for touch input recognition according to grip and/or an interaction context are contemplated. For instance, backside gestures may be selectively turned on/off in different interaction contexts. Likewise in some scenarios, touch input or at least some touch functionality provided via the touchscreen may be disabled based upon grip and context. For example, during game play of a interactive game the relies upon device motion, the touch input may be adapted to minimizes chances of the game being interrupted by inadvertent touches. In the manner just described, the accuracy of gesture recognition may be enhanced in selected areas while at the same time reducing misrecognition of gestures.

Having discussed some example details, consider now an example system that can be employed in one or more embodiments to implement aspects of techniques for grip-based device adaptations in one or more embodiments.

Example System

FIG. 12 illustrates an example system 1200 that includes an example computing device 1202 that is representative of one or more computing systems and/or devices that may implement the various techniques described herein. The computing device 1202 may be, for example, a server of a service provider, a device associated with a client (e.g., a client device), an on-chip system, and/or any other suitable computing device or computing system.

The example computing device 1202 as illustrated includes a processing system 1204, one or more computer-readable media 1206, and one or more I/O interfaces 1208 that are communicatively coupled, one to another. Although not shown, the computing device 1202 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1204 is representative of functionality to perform one or more operations using hardware. Accordingly, the processing system 1204 is illustrated as including hardware elements 1210 that may be configured as processors, functional blocks, and so forth. This may include implementation in hardware as an application specific integrated circuit or other logic device formed using one or more semiconductors. The hardware elements 1210 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 1206 is illustrated as including memory/storage 1212. The memory/storage 1212 represents memory/storage capacity associated with one or more computer-readable media. The memory/storage 1212 may include volatile media (such as random access memory (RAM)) and/or nonvolatile media (such as read only memory (ROM), Flash memory, optical disks, magnetic disks, and so forth). The memory/storage 1212 may include fixed media (e.g., RAM, ROM, a fixed hard drive, and so on) as well as removable media (e.g., Flash memory, a removable hard drive, an optical disc, and so forth). The computer-readable media 1206 may be configured in a variety of other ways as further described below.

Input/output interface(s) 1208 are representative of functionality to allow a user to enter commands and information to computing device 1202, and also allow information to be presented to the user and/or other components or devices using various input/output devices. Examples of input devices include a keyboard, a cursor control device (e.g., a mouse), a microphone for voice operations, a scanner, touch functionality (e.g., capacitive or other sensors that are configured to detect physical touch), a camera (e.g., which may employ visible or non-visible wavelengths such as infrared frequencies to detect movement that does not involve touch as gestures), and so forth. Examples of output devices include a display device (e.g., a monitor or projector), speakers, a printer, tactile-response device, and so forth. The computing device 1202 may further include various components to enable wired and wireless communications including for example a network interface card for network communication and/or various antennas to support wireless and/or mobile communications. A variety of different types of antennas suitable are contemplated including but not limited to one or more Wi-Fi antennas, global navigation satellite system (GNSS) or global positioning system (GPS) antennas, cellular antennas, Near Field Communication (NFC) 214 antennas, Bluetooth antennas, and/or so forth. Thus, the computing device 1202 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 1202. By way of example, and not limitation, computer-readable media may include “computer-readable storage media” and “communication media.”

“Computer-readable storage media” refers to media and/or devices that enable storage of information in contrast to mere signal transmission, carrier waves, or signals per se. Thus, computer-readable storage media does not include signal bearing media or signals per se. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Communication media” refers to signal-bearing media configured to transmit instructions to the hardware of the computing device 1202, such as via a network. Communication media typically may embody computer readable instructions, data structures, program modules, or other data in a modulated data signal, such as carrier waves, data signals, or other transport mechanism. Communication media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1210 and computer-readable media 1206 are representative of instructions, modules, programmable device logic and/or fixed device logic implemented in a hardware form that may be employed in some embodiments to implement at least some aspects of the techniques described herein. Hardware elements may include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing may also be employed to implement various techniques and modules described herein. Accordingly, software, hardware, or program modules including skin driver module 116, device applications 110, and other program modules may be implemented as one or more instructions and/or logic embodied on some form of computer-readable media and/or by one or more hardware elements 1210. The computing device 1202 may be configured to implement particular instructions and/or functions corresponding to the software and/or hardware modules. Accordingly, implementation of modules as a module that is executable by the computing device 1202 as software may be achieved at least partially in hardware, e.g., through use of computer-readable storage media and/or hardware elements 1210 of the processing system. The instructions and/or functions may be executable/operable by one or more articles of manufacture (for example, one or more computing devices 1202 and/or processing systems 1204) to implement techniques, modules, and examples described herein.

As further illustrated in FIG. 12, the example system 1200 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 1200, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link.

In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 1202 may assume a variety of different configurations, such as for computer 1214, mobile 1216, and television 1218 uses. Each of these configurations includes devices that may have generally different constructs and capabilities, and thus the computing device 1202 may be configured according to one or more of the different device classes. For instance, the computing device 1202 may be implemented as the computer 1214 class of a device that includes a personal computer, desktop computer, a multi-screen computer, laptop computer, netbook, and so on.

The computing device 1202 may also be implemented as the mobile 1216 class of device that includes mobile devices, such as a mobile phone, portable music player, portable gaming device, a tablet computer, a multi-screen computer, and so on. The computing device 1202 may also be implemented as the television 1218 class of device that includes devices having or connected to generally larger screens in casual viewing environments. These devices include televisions, set-top boxes, gaming consoles, and so on.

The techniques described herein may be supported by these various configurations of the computing device 1202 and are not limited to the specific examples of the techniques described herein. This is illustrated through inclusion of the skin driver module 116 on the computing device 1202. The functionality of the skin driver module 116 and other modules may also be implemented all or in part through use of a distributed system, such as over a “cloud” 1220 via a platform 1222 as described below.

The cloud 1220 includes and/or is representative of a platform 1222 for resources 1224. The platform 1222 abstracts underlying functionality of hardware (e.g., servers) and software resources of the cloud 1220. The resources 1224 may include applications and/or data that can be utilized while computer processing is executed on servers that are remote from the computing device 1202. Resources 1224 can also include services provided over the Internet and/or through a subscriber network, such as a cellular or Wi-Fi network.

The platform 1222 may abstract resources and functions to connect the computing device 1202 with other computing devices. The platform 1222 may also serve to abstract scaling of resources to provide a corresponding level of scale to encountered demand for the resources 1224 that are implemented via the platform 1222. Accordingly, in an interconnected device embodiment, implementation of functionality described herein may be distributed throughout the system 1200. For example, the functionality may be implemented in part on the computing device 1202 as well as via the platform 1222 that abstracts the functionality.

### CONCLUSION

Although aspects of grip-based device adaptation have been described in language specific to structural features and/or methodological acts, it is to be understood that the subject matter defined in the appended claims is not necessarily limited to the specific features or acts described. Rather, the specific features and acts are disclosed as example forms of implementing the claimed subject matter.

What is claimed is:

1. A method comprising:
obtaining input associated with one or more skin sensors of a touch-aware skin for a computing device;
detecting grip characteristics based upon the input;
selectively customizing a presentation of one or more on-screen input elements exposed in a user interface of the computing device according to the detected grip characteristics.

2. The method of claim 1, wherein selectively customizing the presentation of the one or more on-screen elements comprises adapting the one or more screen elements by changing one or more of a size, a location, or touch sensitivity of the one or more on-screen elements according to the detected grip characteristics.

3. The method of claim 1, wherein selectively customizing the presentation of the one or more on-screen input elements comprises presenting an on-screen keyboard that is configured to correspond to the detected grip characteristics.

4. The method as described in claim 3, wherein presenting the on-screen keyboard that is configured to correspond to the detected grip characteristics comprises selecting a type of on-screen keyboard to present from multiple available on-screen keyboard options based upon the detected grip characteristics.

5. The method as described in claim 4, wherein presenting the on-screen keyboard that is configured to correspond to the detected grip characteristics further comprises adapting at least one of a size, a location, or touch sensitivity of one or more keys of the on-screen keyboard according to the to the detected grip characteristics.

6. The method of claim 1, wherein selectively customizing the presentation of the one or more on-screen elements comprises selecting to display either a split on-screen keyboard or a contiguous keyboard in the user interface based upon a location of a user's grip indicated by the detected grip characteristics.

7. The method of claim 1, wherein the one or more on-screen input elements comprise at least one of a window, a dialog box, a pop-up box, a menu, or a command element.

8. The method of claim 1, wherein the grip characteristics include size, location, shape, orientation, applied pressure, and number of contact points associated with a user's grip of the computing device that are determined based upon the input obtained from the one or more skin sensors.

9. The method of claim 1, further comprising adjusting one or more parameters used for touch input recognition to change touch sensitivity for one or more locations of the computing device based upon the detected grip characteristics.

10. The method of claim 1, wherein the one or more skin sensors are configured to detect direct contact with the touch-aware skin, proximity to the touch-aware skin, forces applied to the touch-aware skin, and deformations of the touch-aware skin.

11. The method as described in claim 1, wherein detecting the grip characteristics comprises detecting user-specific information to customize grip-based device adaptations in a user-specific manner.

12. The method as described in claim 1, wherein the grip characteristics are indicative of a particular way in which a user holds the computing device.

13. A computing device comprising:
a processing system;
a touch-aware skin having one or more skin sensors; and
a skin driver module operable via the processing system to control the touch-aware skin including:
detecting grip characteristics based upon input received at skin sensor locations of the touch-aware skin;
recognizing input indicative of a gesture to launch an on-screen keyboard; and
responsive to the gesture, automatically presenting an on-screen keyboard that is configured to correspond to the detected grip characteristics.

14. The computing device as described in claim 13, wherein the input indicative of the gesture to launch the on-screen keyboard comprises an inward swiping motion toward a center of a display of the computing device in relation to at least one contact point associated with each a user's hands indicated by the detected grip characteristics.

15. The computing device as described in claim 13, wherein the input the indicative of the gesture to launch the on-screen keyboard comprises an inward swiping motion on a back-side of the device opposite a display of the device in relation to multiple contact points associated with a user's grip on the device indicated by the detected grip characteristics.

16. The computing device as described in claim 13, wherein:
the on-screen keyboard is selected as a split keyboard based upon the detected grip characteristics; and
the split keyboard includes two individual portions that are positioned and aligned according to a user's grip indicated by the detected grip characteristics and configured to independently track movement of respective hands of the user's grip.

17. One or more computer-readable storage media storing instructions that, when executed via a computing device, cause the computing device to implement a skin driver module configured to perform operations including:
detecting a grip applied to a computing device through a touch-aware skin of the computing device;
determining an interaction context based at least in part upon the detected grip; and
adjusting one or more parameters used for touch input recognition according to the interaction context.

18. One or more computer-readable storage media as described in claim 17, wherein the one or more parameters used for touch input recognition include one or more of velocity of input, timing parameters, size of contacts, length of contacts, number of sensor points, or applied pressure.

19. One or more computer-readable storage media as described in claim 17, wherein adjusting the one or more parameters comprises adapting threshold values associated with the one or more parameters based upon the interaction context, the threshold values used as a basis for recognition of gestures defined as combinations of the one or more parameters.

20. One or more computer-readable storage media as described in claim 17, further comprising adapting the sensitivity of one or more sensors in particular areas of the device based upon the interaction context.
